(19) United States
(12) Patent Application Publication
(10) Pub. No.: US 2010/0121709 A1
(43) Pub. Date: May 13, 2010

(54) INVITATION-BASED VIRAL ADVERTISING

(75) Inventors: Evgeny Berezin, Helsinki (FI); Zoltan Ordogh, Tampere (FI); Michael John Rooke, Hyvinkaa (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/268,359

(22) Filed: Nov. 10, 2008

(51) Int. Cl. G06Q 30/00; G06F 17/00; G06F 15/16

(52) U.S. Cl. 705/14.51; 705/10; 709/206

(57) ABSTRACT

Direct and indirect invitation-based viral advertising is provided, where an advertisement is delivered to a first user. The first user may send an invitation message to a second user inviting him/her to view/interact with the advertisement. The invitation message can be sent directly from the first user's device or indirectly sent from an advertising server. Upon acceptance by the second user of the invitation message regarding the advertisement, an opt-in form an optional opt-in form, or no opt-in form is presented to the second user. The opt-in form can be used by the second user to register with an advertising network that created, is associated with, and/or originally delivered the advertisement to the first user. Upon receipt of opt-in information associated with the second user for populating/answering the opt-in form, the opt-in form is processed for the second user. Then, the advertisement is delivered to the second user.

### FIELD OF THE INVENTION

Various embodiments relate generally to Internet and mobile advertising. More particularly, various embodiments relate to an “invitation-based” viral advertising method in the Internet and mobile advertising environment.

### BACKGROUND

This section is intended to provide a background or context to various embodiments recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In the conventional Internet/mobile advertising model, users receive advertisements/ads embedded in content that is downloaded from the Internet (for example, banner ads embedded/referenced in fetched web pages). Users may interact with an ad by, e.g., selecting/clicking on the ad. When the ad is selected/clicked, a browser loads a resource referenced by the ad, which will result in actions including, but not limited to the following: going to an advertiser's web site (using a Hypertext Transport Protocol (HTTP) Uniform Resource Identifier (URI)); initiating a phone call (using, e.g., a Skype or similar Voice over Internet Protocol (VoIP) URI); opening up a new message window (using mailto or some similar URI) to send a message (e.g., email, short message service (SMS) message, multimedia messaging service (MMS) message, instant messaging (IM) message, etc); and forwarding the ad to a friend.

The “forwarding the ad to a friend” option enables what is referred to as a “viral advertising” model. In the viral advertising model, an initial set of users receive ads using the conventional Internet/mobile advertising model. However, the initial set of users is expanded by allowing users to forward ads to other users based on the presumption that the users know what their friends are interested in, ultimately resulting in more efficient advertising. Viral advertising thus helps advertisers expand their target audience by using “word of mouth” marketing.

The “forwarding the ad to a friend” viral advertising model is typically implemented in the following way. A user clicks an ad and chooses a “forward to friend”/“let a friend know” option. The user enters, e.g., a friend's network identity (such as an email/IM address, mobile phone number, etc.) and confirms forwarding of the ad. Alternatively, the user can choose the friend's contact information from an address book on the user's device. The same ad is then delivered to the friend in the form of an email, SMS, MMS, IM message, or by some other method. The friend receives the forwarded ad and is presented with two options: a) reject the ad; or b) view the ad. If friend chooses option ‘b’, he/she is presented with the ad. Thereafter, the friend can interact with the ad in the same way as the original user (including forwarding the ad to yet another friend/user).

There are two ways of implementing delivering the same ad to the friend—the direct method, and the indirect method. With the direct method, the user's device sends the same ad to directly to the friend's device. With the indirect method, the user's device sends the same ad (or sends the same ad's identity) to the advertising server, which further sends the same ad to the designated friend. With the indirect method, the advertising server has the possibility to check friend's eligibility for receiving the ad, and reject ad forwarding if needed.

The ad forwarding viral advertising model described above, has the following drawbacks. An ad is pushed from a user to a friend without the friend's consent (opt-in). Therefore, the ad forwarding viral advertising model pushes ads to a friend regardless of whether or not the friend is interested in the ad, whether or not the friend actually knows the user, whether the friend actually meets targeting criteria associated with the ad, whether or not the friend's device has an application capable of showing this type of ad, and whether or not the friend's device has an advertising client software present. Furthermore, such non-consensual pushing of ads can result in forcing advertisements onto the friend that are not relevant to him/her, which ultimately can lead to ads being considered spam. Moreover, it is likely that the friend will simply begin blocking subsequent ad forwards from the user.

Additionally, an advertising server that provides an ad may not have any information about the friend. If friend has viewed and acted on a forwarded ad, metrics should be reported to the advertising server. However, information about friend does not exist in the advertising server, rendering metrics reporting overly complicated (if not impossible) with the conventional advertising models described above.

Further still, a forwarded ad can be a part of a campaign where different ads are logically linked to each other. For example, a forwarded ad about an upcoming concert may advertise related products and/or services that are part of a deal being promoted by the forwarded ad, e.g., concerts of the same musician/genre, good deals on tickets for a series of concerts, free T-Shirts, etc. For a friend, receiving a single forwarded ad associated with an entire ad campaign introduces certain issues. That is, the friend's perception of the ad is not consistent with the entire message/campaign from the advertiser (e.g., that attending an entire series of concerts is as cheap as attending two or three concerts). Moreover, the friend will not be aware of the related product/service deals that he/she might be interested in (e.g., going to another concert, purchasing concert promotional products, etc.)

### SUMMARY OF VARIOUS EMBODIMENTS

Various embodiments enable invitation-based viral advertising. An advertisement is delivered to a first user. The first user may then send an invitation message to a second user inviting him/her to view/interact with the advertisement. The invitation message can be directly sent from the first user's device or can be indirectly sent from an advertising server, where an invitation request is sent by the first user to the advertising server, after which, the advertising server may send the invitation message to the second user. Upon acceptance by the second user of one of the directly sent and indirectly sent invitation messages regarding the advertisement, an opt-in form is presented to the second user. The opt-in form can be used by the second user to register with an advertising network that created, is associated with, and/or originally delivered the advertisement to the first user. Upon receipt of opt-in information associated with the second user for populating/answering the opt-in form, the opt-in form is processed for the second user. Then, the advertisement is delivered to the second user.

One exemplary embodiment relates to a method of invitation-based viral advertising. The method includes delivering an advertisement to a first user. Upon acceptance by a second user of one of a directly and indirectly sent invitation message sent by the first user regarding the advertisement, the advertisement is delivered to the second user, The delivery of the advertisement to the second user is performed either without further interaction or pursuant to one of: presentation of an opt-in form to the second user and upon receipt of opt-in information for populating the opt-in form, processing the opt-in form for the second user; and presentation of an optional opt-in form to the second user.

Another exemplary embodiment relates to an apparatus for invitation-based viral advertising comprising an electronic device. The apparatus is configured to deliver an advertisement to a first user. Upon acceptance by a second user of one of a directly and indirectly sent invitation message from the first user regarding the advertisement, the apparatus delivers the advertisement to the second user. The delivery of the advertisement to the second user is performed either without further interaction or pursuant to one of: presentation of an opt-in form to the second user and upon receipt of opt-in information for populating the opt-in form, processing the opt-in form for the second user; and presentation of an optional opt-in form to the second user.

Yet another exemplary embodiment relates to an apparatus for invitation-based viral advertising. The apparatus comprises means for means for delivering an advertisement to a first user. The apparatus further comprises means for, upon acceptance by a second user of one of a directly and indirectly sent invitation message sent by the first user regarding the advertisement, delivering the advertisement to the second user. The delivery of the advertisement to the second user is performed either without further interaction or pursuant to one of: presentation of an opt-in form to the second user and upon receipt of opt-in information for populating the opt-in form, processing the opt-in form for the second user; and presentation of an optional opt-in form to the second user.

Users are more likely to trust invitations received from users with whom a relationship exists. In accordance with various embodiments, a user receives “viral” ads only upon opting in to an advertising network. In accordance with other embodiments, the opting in to the advertising network may be optional. Related metrics reporting and future ad campaign targeting is made easier to achieve. Additionally, a better knowledge of target audiences is provided to an advertiser. Furthermore, fewer opportunities for spam, abuse, fraud, etc. exist when relying upon invitations as described in accordance with various embodiments. Invitations originating from unknown addresses can be filtered out. Further still and with regard to indirect invitation-based viral advertising, an advertising server has the opportunity to detect and discard invitations that are or seem suspicious before they ever reach a second user. When a “viral” ad (i.e., the original ad) is a part of a larger ad campaign, the second user is substantially assured of receiving all ads linked to the “viral” ad in a consistent manner. Hence, the user experience is improved, as well receiving “consistent” messages from advertisers.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 illustrates a message flow of a direct invitation-based viral advertising model from a first user's perspective in accordance with various embodiments;

FIG. 2 illustrates a message flow of a direct invitation-based viral advertising model from a second user's perspective in accordance with various embodiments;

FIG. 3 is a message flow of a direct invitation-based viral advertising model from a network element/device application perspective in accordance with various embodiments;

FIG. 4 is a message flow of an indirect invitation-based viral advertising model from a network element/device application perspective in accordance with various embodiments;

FIG. 5 is a flow chart illustrating exemplary processes performed by an advertisement server during indirect invitation-based viral advertising in accordance with various embodiments;

FIG. 6 is a is a flow chart illustrating exemplary processes performed by an advertisement server during direct invitation-based viral advertising in accordance with various embodiments;

FIG. 7 is an overview diagram of a system within which various embodiments may be implemented;

FIG. 8 is a perspective view of an electronic device that can be used in conjunction with the implementation of various embodiments; and

FIG. 9 is a schematic representation of the circuitry which may be included in the electronic device of FIG. 8.

### DETAILED DESCRIPTION OF VARIOUS EMBODIMENTS

Various embodiments provide alternative systems and methods of advertising to conventional the “ad forwarding” viral advertising model. Instead of users being flooded with ads from un-trusted sources, ad invitations are received from “trusted” users/friends. The invitation is a message that can be sent over any existing or future solution, where the more advanced the technology is, the more sophisticated the invitation can be. For example, an SMS message can include a short text message and a URI, whereas a MMS message could include a picture, rich text about, e.g., a product; and an email message. An IM message can include HTML-formatted content allowing a recipient user to click on, e.g., a product image. It should be noted that various embodiments may be implemented in other types of mobile and/or Internet advertising environments.

For purposes of description herein, the following terms are denoted. A “User” is a person who accesses and consumes network services (in particular, the advertising service). A “Device” refers to hardware equipment (e.g., a mobile terminal) which is used by the User for accessing and consuming network services. A “Service Provider” is a business entity (e.g., a mobile operator) that offers an advertising service to Users. An “Ad Server” is a network-resident advertising server that belongs to the Service Provider. The Ad Server provides the advertisement content to Users, and collects/stores information about the Users and their advertising preferences. An “Ad Engine” refers to a Device-resident advertising software client that belongs to the Service Provider. The Ad Engine interacts with different Ad Apps (described below) and performs functions including, but not limited to the following: obtaining appropriate ads from the Ad Server; selecting ads from a local storage; and providing metrics-related feedback to the Ad Server. An “Ad App” is a Device-resident “ad-aware” application (e.g., a browser, a messaging client, a media player, a maps application) that interacts with the Ad Engine in order to present an advertisement(s) to the User and reports ad impressions/User ad actions.

Furthermore, the following conventions are used in describing various embodiments herein. An (originating) User who initiates viral advertising is referred to as “User A.” A (recipient) User who receives the viral advertising as “User B.” The Ad Engine residing in User A's device is referred to as “Ad Engine A.” The Ad Engine residing in User B's device is referred to as “Ad Engine B.” The Ad App residing on User A's device is referred to as “Ad App A.” The Ad App residing on User B's device is referred to as “Ad App B.”

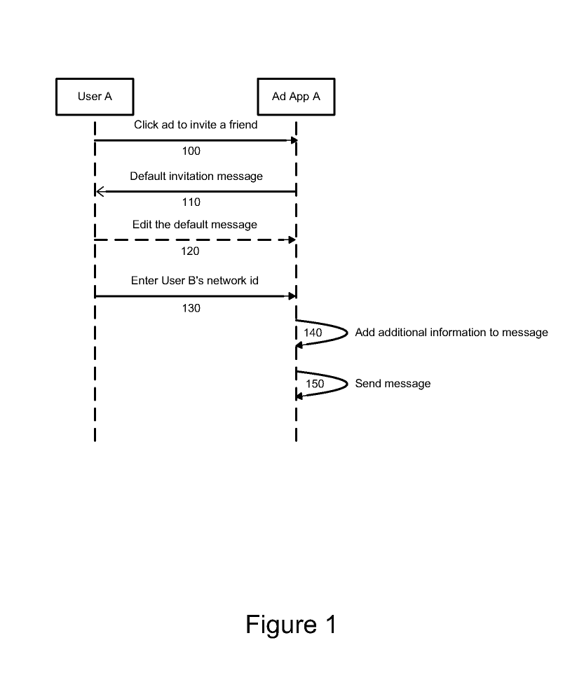

FIG. 1 illustrates an exemplary message/call flow describing various messages sent/received from a first user's (User A's) perspective in a viral advertising model in accordance with one embodiment. At 100, User A clicks an ad presented by Ad App A to invite a friend. For example, User A chooses a “forward to friend”/“let a friend know” option from a pop-up menu displayed by/via Ad App A. Ad App A creates a default invitation message at 110 and adds basic information to the message, which is sent to User A. The basic information can include, e.g., default invitation text such as “Hi, User B. User A invites you to take a look at XYZ's car advertisement.” Other basic information that can be included is the XYZ ad network's logo, an <Opt-In URI> which includes a reference to the Ad Server's opt-in business logic, along with User A's identity in XYZ's network. Alternatively and to shorten the <Opt-In URI>, Ad App A can contact Ad Engine A (not shown) (e.g., in a background process so as not to delay User A's experience) to have an <Opt-In URI> generated by an Ad Server based on the advertisement and User A's identity. It should be noted that providing/utilizing a shortened <Opt-In URI> may also aid in the filtering out of abusive/fraudulent ads.

If desired, at 120, User A can edit the default message, by, e.g., replacing the default message with a personal message to User B, changing some text within the default message, etc. For example, User A can replace the default message with a personalized message such as “Hi, remember that we've talked about ABC's new hybrid car models? Well, I have some information from XYZ, and I thought it might interest you. Check it out: <Opt-In URI>.”

At 130, User A enters User B's network identity, e.g., email/IM address, mobile phone number, etc. User B can be a friend, an acquaintance, a family member, etc. of/related to User A. Again and in accordance with various embodiments, “trusted” advertising is provided, and hence, User A should have some type of “trusted” relationship with User B. Alternatively, User A can select User B's contact information from, e.g., an address book, previous email message, etc., located/implemented in User A's device. At 140, Ad App A adds the additional information to the default/personalized message, such as the topic/subject of the ad (which can be taken from the ad's metadata), a quote from the original ad's “material”/content (e.g., text, image, audio, video, etc). The quote's content can be defined in ad metadata. It can be either the content itself (embedded into the invitation) or a link/control button pointing to the content located elsewhere. At 150, Ad App A sends the composed invitation message to User B (in the direct method), or to the Ad Server for further sending it to User B (in the indirect method). Ad App A may delegate the task of sending the invitation message to Ad Engine A. In the direct method, the Ad App can optionally communicate with the Ad Server (via the Ad Engine or directly) in order to check one or more permissions for using this ad for invitations.

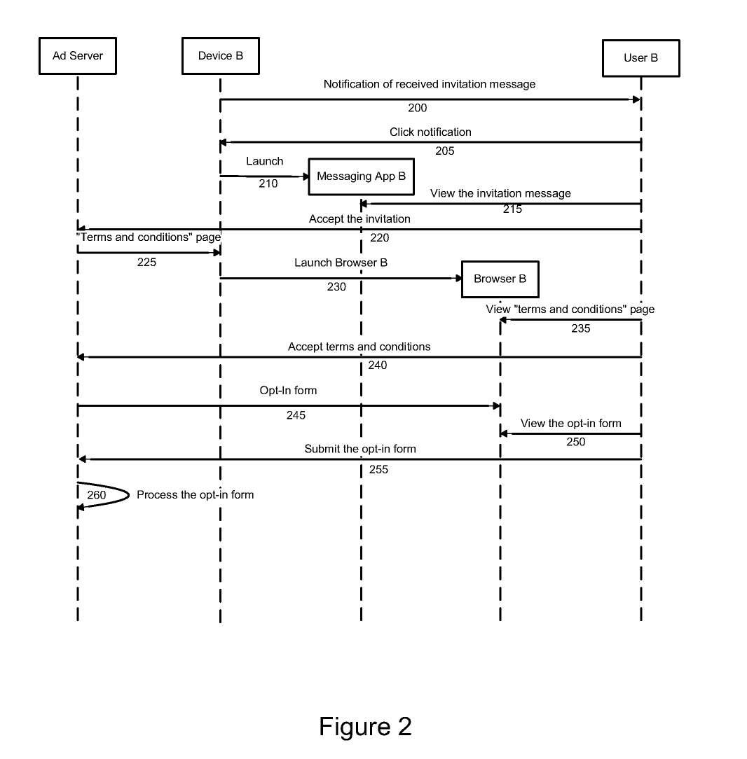

Continuing with the exemplary message flow described in FIG. 1, FIG. 2 illustrates an exemplary message/call flow describing various messages sent/received from a second user's (User B's) perspective in a viral advertising model in accordance with one embodiment. As described above, the invitation message is sent by User A to User B (indirectly through the Ad Server, or directly) in the form of an email, SMS, MMS, IM message, etc. At 200, Device B notifies User B of the invitation message by showing a notification regarding the invitation received from User A. Before opening the message, User B can ascertain that, e.g., User A has sent the message and the topic/subject of the ad. It should be noted that other relevant information may be presented to User B prior to User B opening/viewing the received message. Because User B has a trusted relationship with User A, User B can be at least substantially assured that the received message is not, e.g., spam, an inappropriate ad, etc. Alternatively, Device B can use filtering software to automatically drop invitation messages whose sender does not correspond with someone in User B's contact list, or whose sender corresponds with someone in User B's black list.

At 205, User B can click the notification to open the received message. At 210, a Messaging App B resident on the device of User B is launched, in order to show the invitation message's content. At 215, the invitation message is viewed by User B. After opening the message, User B can see various information including, but not limited to the following: the XYZ ad network's logo; the default/personal message from User A including the <Opt-In URI>; a quote from the original ad's material/content which can be shown/played or otherwise presented appropriately based on the type of material/content either immediately upon opening the invitation message, or after user B has clicked the quote's relevant link(s)/control button; and any other information that User A or Ad App A has added to the invitation message.

If User B is interested in the invitation, he/she accepts the invitation by clicking the <Opt-In URI> at 220. At 225, the Ad Server runs the opt-in business logic. If User B is not yet a member of XYZ ad network, then the Ad Server responds with a web page containing information such as, e.g.,: the benefits of joining XYZ Ad network (service discounts, coupons etc); XYZ's advertising terms and conditions, which User B has to accept if he is to join XYZ; an “accept terms and conditions” link or control button; any other information specific for XYZ advertising network. At 230, Device B launches a Browser B to show the web page. At 235, User B views the web page in Browser B. At 240, User B accepts the terms and condition by clicking the “accept terms and conditions” link or control button.

At 245, the Ad Server responds with the opt-in form, which could contain the following fields: user's personal information (name, age address, network identities); user's advertising preferences (topics/subjects of interest); and a default reply message to User A. It should be noted that User B has may be allowed to override the default reply message with a personal reply message such as “Hi, thanks a lot! Let's discuss this on lunch tomorrow.”; and/or any other information specific for/to the XYZ advertising network. Some fields may be pre-populated based on known information about User B, such as his/her network identity, and ABC Car's “topic of interest” (known from the invitation).

At 250, User B views the opt-in form in Browser B. At 255, User B fills out the opt-in form and submits it to the Ad Server. At 260, the Ad Server processes the opt-in information from the opt-in form and adds User B to XYZ ad network's members. It is possible that Device B is offline when User B views and accepts the invitation message. In this case, Ad Engine B (not shown) acting as an advertising software client can assume the role of the Ad Server's “offline proxy” (assuming that the Ad Server is known to the Ad Engine B before User B has opted-in to the XYZ ad network). When online, the Ad Engine B can preferably pre-fetch the following from the Ad Server: User B's profile (if it exists), or otherwise, the informational web page; and a template for the opt-in web page.

If User B accepts an invitation message when Device B is offline, Ad Engine B checks the existence of and the content of the pre-fetched User B's profile, and simulate the Ad Server's actions (e.g., processes 225-260 described above) assuming the role of the Ad Server and using the pre-fetched information. The Ad Engine B can generate the opt-in web page (using the pre-fetched template), present it to User B using Browser B, receive User B's opt-in input/information, create or edit User B's profile, and store it temporarily in Device B. Once Device B goes online, Ad Engine B communicates the updated User B's profile to the Ad Server (similar to process 255).

It is also possible for Ad Engine B to obtain ad repository (the whole or a part of) from the Ad Server, and cache it internally. After successful execution of the above call flow (or the “offline” alternative described above), Ad Engine B can find the original ad in the cache. In this case, Ad Engine B can “serve” the ad to User B from the cache, rather than from the Ad Server.

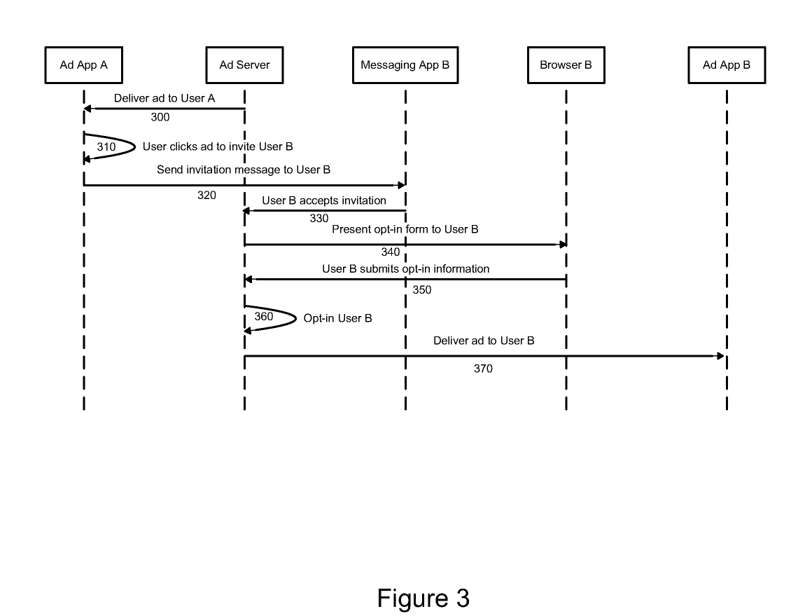

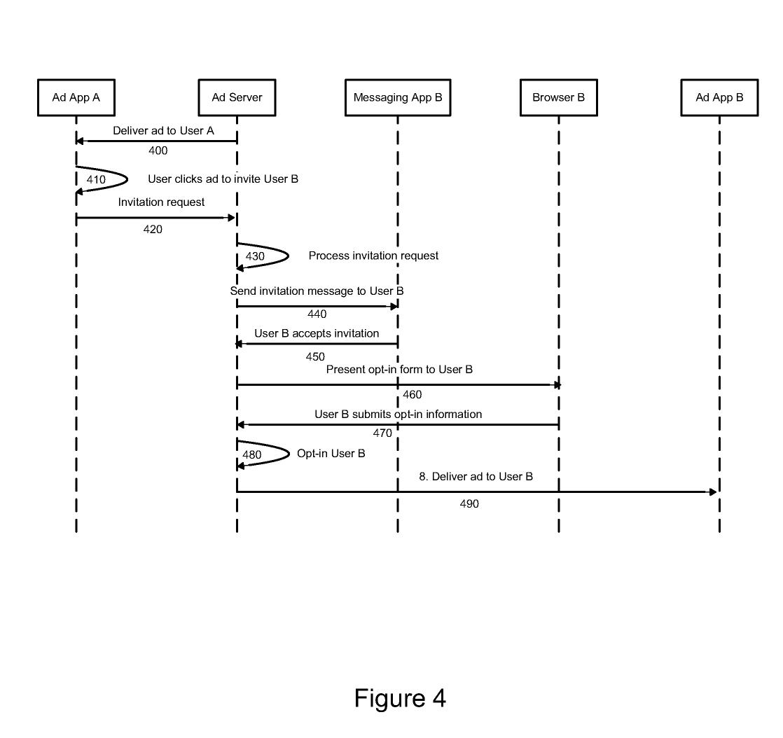

Additionally and with regard to the direct and indirect viral advertising models in accordance with various embodiments, FIGS. 3 and 4 illustrate exemplary message/call flows from a network element/device perspective. Invitation-based viral advertisements in accordance with various embodiments can be direct or indirect. For the sake of clarity, these call flows are illustrated at a high-level, and omit the following details: User interactions with Ad Apps; Ad Engine A, Ad Engine B, and relevant communications therebetween, although it should be noted that each process showing communication(s) between device applications and the Ad Server may involve communication with the corresponding Ad Engine (if an Ad Engine is present on the User's device), and thus these call flows are applicable regardless of the presence of any Ad Engine; reporting metrics about User A's interactions with ads, and metrics about User B accepting invitation; any confirmation or information process(es) such as notifying User A after User B has accepted his/her invitation and launching Messaging App B, Browser B, and Ad App B on User B's device, e.g., Device B.

FIG. 3 is a message flow of a direct invitation-based viral advertising model from a network element/device application perspective in accordance with various embodiments. At 300, an ad is delivered to User A via Ad App A from an Ad Server. At 310, User A clicks on the delivered Ad through Ad App A to invite User B, whereupon an invitation message is sent at 320 directly to User B, by way of Messaging App B. User B may accept the invitation from User A at 330 via Messaging App B. The Ad Server then presents an opt-in for advertising form (such as that described above) to Browser B at 340. Again and as described above, User B via Browser B may peruse the opt-in for advertising information and/or other relevant information on associated web pages and the like. If User B chooses to join this particular Ad network, User B submits the opt-in for advertising form along with the requisite information at 350 back to the Ad Server. At 360, the Ad Server can process the opt-in for advertising form/information and “opt-in” User B. At 370, the ad originally sent to User A can be delivered to User B via Ad App B. It should be noted that the opt-in for advertising form can be implemented in various ways, such as a sequence of question and answer windows or web pages, and is not limited to a traditional type of form. Moreover, the opt-in for advertising form can be populated by User B using User B's device, or can be later populated, e.g., at the Ad Server upon receipt of the relevant opt-in information.

FIG. 4 is a message flow of an indirect invitation-based viral advertising model from a network element/device application perspective in accordance with various embodiments. As was described above with regard to FIG. 3, FIG. 4 illustrates that at 400, an ad is delivered to User A via Ad App A from an Ad Server. At 410, User A clicks on the delivered ad through Ad App A to invite User B. However and unlike the direct invitation-based model described in FIG. 3, instead, an invitation request is sent from Ad App A to the Ad Server at 420. At 430, the Ad Server processes the invitation request from User A. Here, the Ad Server can perform the following checks, such as: whether or not User B is opted in already; whether or not User B is interested in the topic of the ad; whether or not User B actually knows User A (by checking User B's contacts); whether or not User B wants to receive invitations from User A (by checking User B's black list); whether or not User B's device has an application capable of showing this type of advertisement; whether or not User B's device has Ad Engine B present; and whether or not User B meets the ad campaign's and other targeting criteria. For example there may be “static” targeting criteria—such as age, sex, language, and country; and “dynamic” targeting criteria—such as user preferences, location, state, and presence status. If User B does not match some static campaign's targeting criteria, he/she must be excluded and the invitation should not be sent to him/her. For example, campaign targeting criteria can specify a user age of “between 16 and 20 years.” If User B's age is outside of these limits, he/she must be excluded from the campaign. However and in the event that User B does not match some dynamic campaign targeting criteria, the invitation still can be sent to him/her. For example, the ad campaign may regard discount days at some shopping mall in New York City. The campaign's targeting criteria can restrict the ads to only those users whose current location is within the New York City area to avoid spamming users in other locations. However, when User A (located in New York City sends an invitation to User B, he/she might be unaware of User B's current location. If User B's current location is Philadelphia, it could be a good incentive for User B to accept the invitation and visit New York City for some shopping. It should be noted that in this case, upon filling the opt-in form, User B is subscribed to the topic, but he/she does not receive the ad at 490 (described in greater detail below) immediately. He/she will receive the ad after he/she arrives in New York City. That is, delivery of the ad can be adjusted and/or delayed depending on the above-mentioned targeting criteria and whether or not such criteria meets those of the advertising campaign. It should further be noted that User B (located in Philadelphia) will not likely consider receiving an invitation from User A about discount shopping days in New York City as spam. Based on the results of the aforementioned checks, the Ad Server can perform the following actions: rejecting sending the invitation message to User B; approving sending the invitation message to User B; applying some benefit to User A, such as a reward for sending invitations (e.g., reduced prices, coupons, or money); and billing User A's and User B's action(s) related to the invitations as a separate bill record(s) for the advertiser. It should be noted that more or less checks/actions than the those mentioned above can be performed in accordance with various embodiments.

At 440, the Ad Server sends the invitation message to User B by way of Messaging App B. Hence, the invitation message is sent indirectly to User B via the Ad Server. Utilizing Messaging App B, User B may accept the invitation from User A at 450. The Ad Server then presents an opt-in for advertising form (such as that described above) to Browser B at 460. Again and as described above, User B through the use of Browser B may peruse the opt-in for advertising information and/or other relevant information on associated web pages and the like. If User B chooses to join this particular Ad network, User B submits the opt-in for advertising form along with the requisite information at 470 back to the Ad Server. At 480, the Ad Server can process the opt-in for advertising form/information and “opt-in” User B. At 490, the ad originally sent to User A can be delivered to User B via Ad App B.

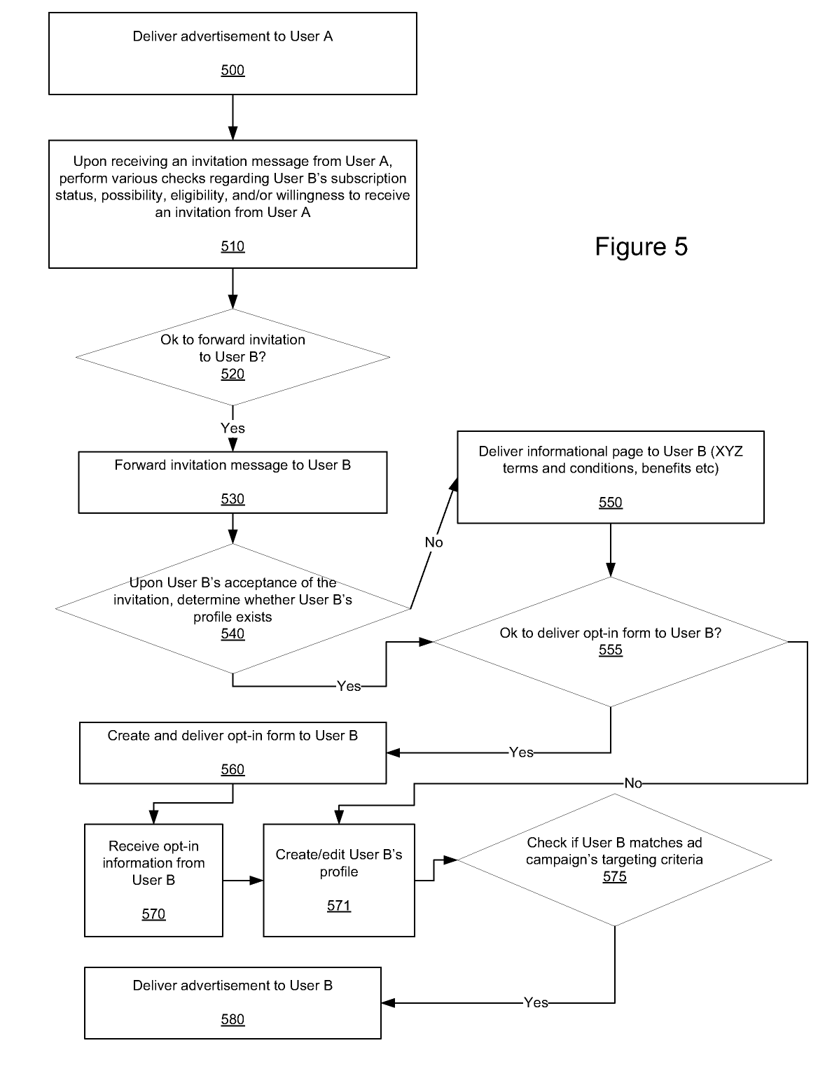

FIG. 5 is a flow chart illustrating various processes performed by the Ad Server during indirect invitation-based viral advertising in accordance with various embodiments. It should be noted that more or less processes may be performed and that the exemplary sequence of operations may be altered in accordance with various embodiments. At 500, an advertisement is delivered to User A. At 510, and upon receiving an invitation message from User A, the Ad Server performs various checks regarding User B including for example, but not limited to User B's subscription status (i.e., whether or not User B is already subscribed to the invitation message's topic/subject), the possibility, the eligibility, and/or the willingness of User B to receive the invitation from User A. At 520, based on the check results, the Ad Server decides whether or not to forward the invitation message to User B. As described above, the Ad Server can add more information to the invitation message, for example, a list of topics/subjects to which User B has subscribed already. At 530, the Ad Server forwards the invitation message to User B. At 540, upon User B's acceptance of the invitation, the Ad Server determines whether or not User B's profile exists. If a profile for User B does not exist, at 550, the Ad Server delivers information (such as via an informational web page) to User B indicative of XYZ ad network's terms and conditions, benefits, etc. If User B's profile is already in existence (or after the deliverance of information at 550), it is determined whether the opt-in form can be delivered to User B at 555. If the opt-in form can be delivered to User B, the Ad Server presents (e.g., creates and delivers) an opt-in form to User B at 560. The content of the opt-in form is adjusted according to User B's current subscription status. For example, if User B's profile already exists, there is no need to include User B's personal information with the opt-in form. Otherwise, at 570, the opt-in information is received from User B. At 571, the Ad Server processes the opt-in form (i.e., creates or edits User B's profile). At 575, the Ad Server checks whether User B matches an ad campaign's targeting criteria. If the targeting criteria is met, at 580, the Ad Server delivers the original ad to User B. It should be noted that as described above, the opt-in form presented to User B may have different versions, with some versions requiring more actions and some versions requiring minimal actions from User B. Additionally, in accordance with some embodiments, presentation of the opt-in form may be optional (e.g., depending on the desired operation, the Ad Server may or may not send an opt-in form). If for example, no opt-in form is sent to User B, the advertisement is delivered to User B after acceptance of the invitation message. If an optional opt-in form is sent to User B, User B may choose to provide the opt-in information or may choose not to, in which case, the advertisement is delivered to User B after the opt-in form is created/delivered to User B, without receiving the opt-in information. Moreover, certain, but not necessarily all embodiments described herein may be configured so that, e.g., User B may still click/select an “opt-in” button on the opt-in form so that at 570, the Ad Server would still receive “opt-in information” even though User B has not entered any information. That is, at least a notification/information indicating that User B did not enter any information is communicated to the Ad Server. Further still, regardless of whether the opt-in form is optional or whether it is optional for User B to enter information for the opt-in form, the Ad Server can be still configured to create/edit a profile for User B. In such an exemplary scenario, at least an advertising topic which User B is opted in for can be recorded in the profile.

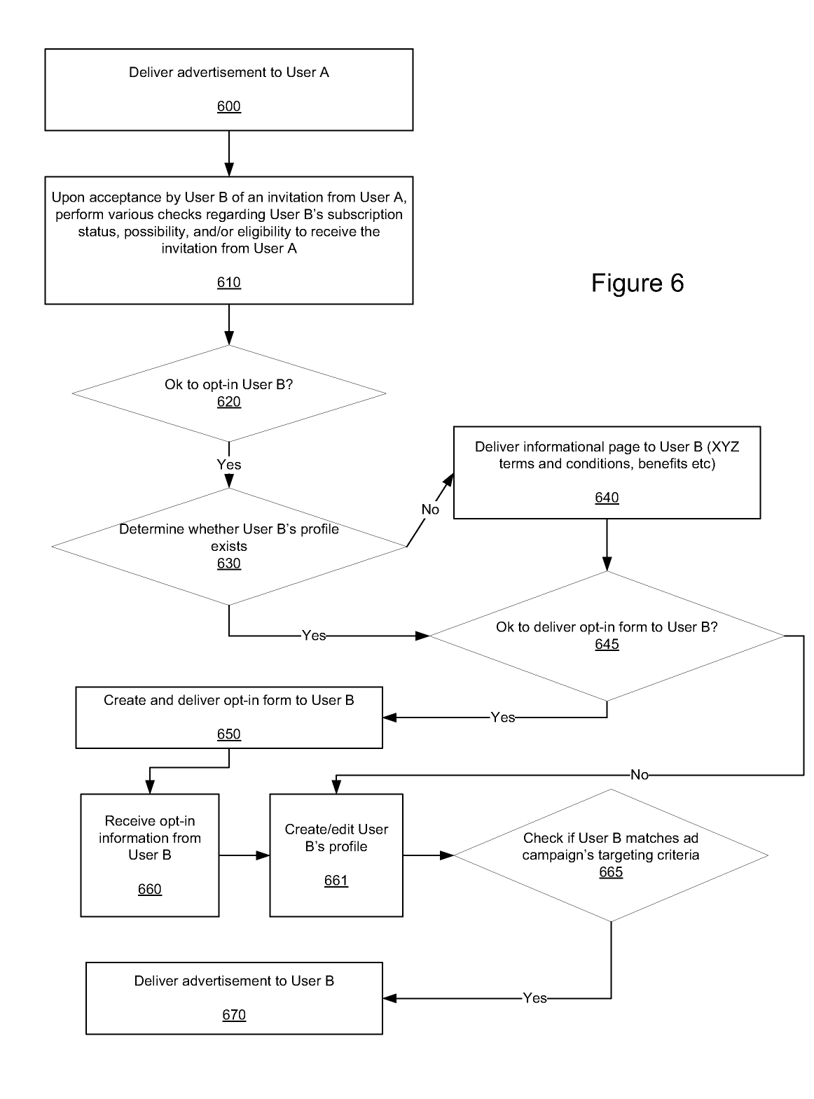

FIG. 6 is a flow chart illustrating various processes performed by the Ad Server during direct invitation-based viral advertising in accordance with various embodiments. It should be noted that more or less processes may be performed and that the exemplary sequence of operations may be altered in accordance with various embodiments. At 600, an advertisement is delivered to User A. At 610, upon User B acceptance of the invitation, the Ad Server performs various checks regarding User B's subscription status, possibility, and/or eligibility to receive the invitation from User A. At 620, based on the check results, the Ad Server decides whether or not to opt-in User B. At 630, the Ad Server checks whether or not User B's profile exists. If not, the Ad Server delivers information (e.g., via an informational web page) to User B indicating XYZ ad network's terms and conditions, benefits, etc. at 640. If User B's profile already exists, (or after the delivering of the information), it is determined whether the opt-in form can be delivered to User B at 645. If so, the Ad Server creates and delivers the opt-in form to User B at 650. The content of the opt-in form is adjusted according to User B's current subscription status. For example if User B's profile already exists, there is no need to include User B's personal information on the opt-in form. Otherwise, at 660, the opt-in information is received from User B. At 661, the Ad Server creates or edits User B's profile. At 665, the Ad Server checks whether User B matches an ad campaign's targeting criteria. If the targeting criteria is met, at 670, the Ad Server delivers the original ad to User B. It should be noted that as described above, the opt-in form presented to User B may have different versions, with some versions requiring more actions and some versions requiring minimal actions from User B. Additionally, in accordance with some embodiments, presentation of the opt-in form may be optional (e.g., depending on the desired operation, the Ad Server may or may not send an opt-in form). If for example, no opt-in form is sent to User B, the advertisement is delivered to User B after acceptance of the invitation message. If an optional opt-in form is sent to User B, User B may choose to provide the opt-in information or may choose not to, in which case, the advertisement is delivered to User B after the opt-in form is created/delivered to User B, without receiving the opt-in information. Moreover, certain, but not necessarily all embodiments described herein may be configured so that, for example, User B may still click/select an “opt-in” button on the opt-in form so that at 660, the Ad Server would still receive “opt-in information” even though User B has not entered any information. That is, and as described above, at least a notification/information indicating that User B did not enter any information is communicated to the Ad Server. Further still, regardless of whether the opt-in form is optional or whether it is optional for User B to enter information for the opt-in form, the Ad Server can be still configured to create/edit a profile for User B. In such an exemplary scenario, at least an advertising topic which User B is opted in for can be recorded in the profile.

It should be noted that prior to the delivery of the ad to User B in accordance with various embodiments, the Ad Server may choose or adjust at least one characteristic of an ad according to capabilities of User B's device. Ad characteristics can include, but are not limited to the following: image resolution, image size, colors of an image, video codec, etc. Additionally, the Ad Server can choose or adjust ad characteristics based on the application resident on User B's device that will present the ad to User B (e.g., Ad App B) and/or certain capabilities of the application.

When a direct invitation model is used as described above, User B is more likely to trust an ad he/she has received directly from User A with whom User B presumably has some relationship with. Moreover, User B receives “viral” ads only after he has opted in to an advertising network, and information about him is known to ad network. This type of information about a user facilitates metrics reporting and future ad targeting. Moreover, a better knowledge of target audiences is provided to an advertiser. Further still, fewer opportunities for spam, abuse, fraud, etc. exist when relying upon invitations as described in accordance with various embodiments. For example, a user will know his/her friends' addresses (and ads originating from unknown addresses can be filtered out). With regard to indirect invitation-based viral advertising, an ad server has the opportunity to detect and discard invitations that are or seem suspicious before they ever reach a user. When “viral” ads are a part of a larger ad campaign, a user is substantially assured of receiving all ads linked to the “viral” ad in a consistent manner. Hence, the user experience is improved, as well receiving “consistent” messages from advertisers.

Additionally and with regard to the above-described aspect of joining an ad network, User B may consider filling the opt-in form and/or providing personal information to an ad network prior to receiving ads to be a barrier and refuse to join the ad network. However, at the ad network's discretion, alternatives can be provided to those users that see opt-in process as a barrier. For example, a user may still be allowed to join the ad network and receive advertisements without filling the opt-in form and/or by pre-populating the opt-in form fields where possible, and/or by making “sensitive” fields optional. That is, the user is not necessarily required to submit information that may be perceived by the user as being too personal in nature (or deemed not necessary for the ad's purpose) on the opt-in (registration) form.

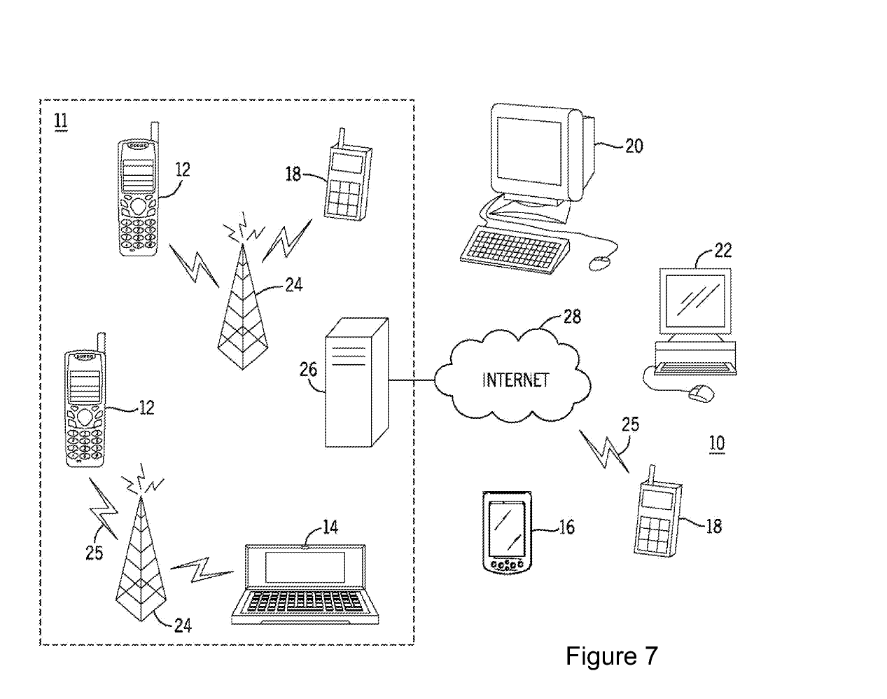

FIG. 7 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 7 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 9 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

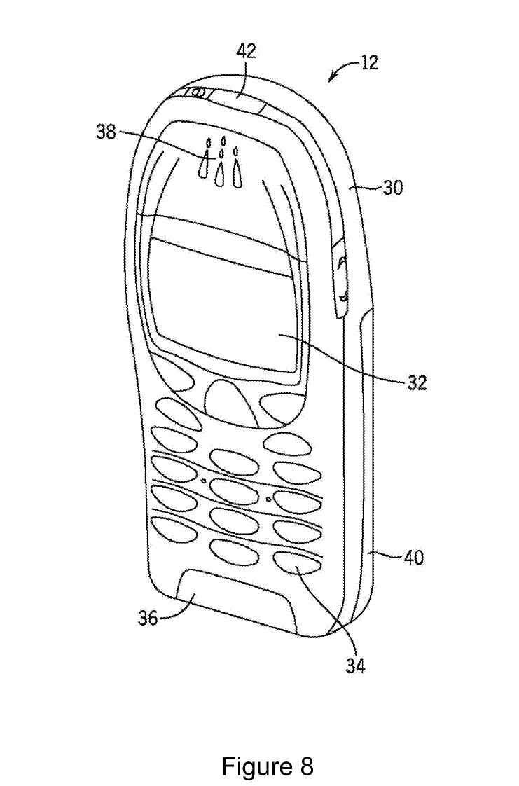

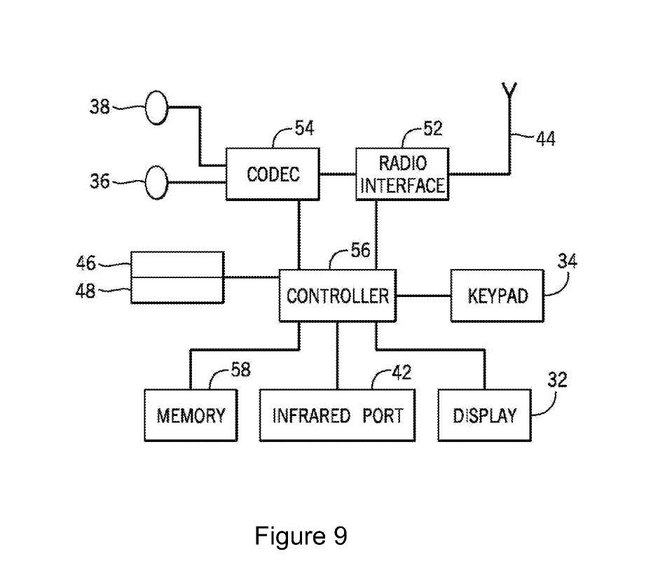

FIGS. 8 and 9 show one representative electronic device 12 within which various embodiments may be implemented. It should be understood, however, that various embodiments are not intended to be limited to one particular type of device. The electronic device 12 of FIGS. 8 and 9 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Various embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit various embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize various embodiments and with various modifications as are suited to the particular use contemplated. The features of the embodiments described herein may be combined in all possible combinations of methods, apparatus, modules, systems, and computer program products.

What is claimed is:

1. A method of invitation-based viral advertising, comprising:
delivering an advertisement to a first user;
upon acceptance by a second user of an invitation message sent by the first user regarding the advertisement, delivering the advertisement to the second user, wherein the delivery of the advertisement to the second user is performed either without further interaction or pursuant to one of:
presentation of an opt-in form to the second user and upon receipt of opt-in information for populating the opt-in form, processing the opt-in form for the second user; and
presentation of an optional opt-in form to the second user.

2. The method of claim 1, wherein the first user and the second user have a trusted relationship, and wherein the delivering of the advertisement is performed by an advertising server.

3. The method of claim 2, wherein at least a portion of the opt-in information is known to the advertising server prior to the presenting of the one of the opt-in form and the optional opt-in form to the second user.

4. The method of claim 2, wherein an advertising software client resident on an advertising-receiving device utilized by the second user acts on behalf of the advertising server when the advertising-receiving device is offline.

5. The method of claim 2, wherein an advertising software client resident on an advertising-receiving device utilized by the second user serves the advertisement from a cache of the advertising-receiving device instead of from the advertising server.

6. The method of claim 1, wherein the invitation message comprises an indirectly sent invitation message sent by the first user and is forwarded to the second user by an intermediate network entity comprising an advertising server.

7. The method of claim 1, wherein the invitation message comprises a directly sent invitation message sent by the first user to the second user without use of an advertising server.

8. The method of claim 1, further comprising, upon rejection by the second user of the one of the invitation message regarding the advertisement, prohibiting the delivery of the advertisement to the second user.

9. The method of claim 1, wherein the invitation message comprises one of a default invitation message and a personalized by the first user invitation message.

10. The method of claim 1, wherein the invitation message comprises a uniform resource identifier identifying an opt-in business logic resource at an advertising server.

11. The method of claim 1, wherein the one of the opt-in form and the optional opt-in form is associated with an advertising network that originally provides the advertisement.

12. The method of claim 11 further comprising, adding a subscription of the second user to the advertising network upon the processing of the one of the opt-in form and the optional opt-in form for the second user.

13. The method of claim 11 further comprising, prior to the presentation of the one of the opt-in form and the optional opt-in form to the second user and upon a determination that a profile of the second user does not exist in association with the advertising network, delivering an informational page to the second user regarding at least one of the advertising network's terms, conditions, and benefits.

14. The method of claim 11, wherein the processing of the one of the opt-in form and the optional opt-in form comprises one of creating and editing a profile of the second user associated with the advertising network.

15. The method of claim 1 further comprising, performing at least one of a plurality of checks regarding at least one of a subscription status of the second user, a possibility of the second user to receive the invitation message, a willingness of the second user to receive the invitation message, and an eligibility of the second user to receive the invitation message.

16. The method of claim 1 further comprising, determining whether the invitation message is potentially fraudulent.

17. The method of claim 1, wherein the advertisement is one of a plurality of advertisements comprising an advertising campaign.

18. The method of claim 1, wherein the advertisement is associated with an advertising campaign, and wherein delivery of the advertisement is based upon at least one criteria of the advertising campaign.

19. The method of claim 18, wherein the at least one of the criteria of the advertising campaign comprises one of a location, a presence status, and a state of the second user, and wherein the delivery of the advertisement is one of adjusted and delayed until the one of the location, the presence status, and the state of the second user meets the criteria of the advertising campaign.

20. The method of claim 1 further comprising, prior to the delivery of the advertisement to the second user, at least one of choosing and adjusting at least one characteristic of the advertisement according to capabilities of an advertisement-receiving device utilized by the second user.

21. The method of claim 1 further comprising, prior to the delivery of the advertisement to the second user, at least one of choosing and adjusting at least one characteristic of the advertisement according to at least one of an application and capabilities of the application utilized for presenting the advertisement on an advertising-receiving device utilized by the second user.

22. The method of claim 1, wherein the presentation of the opt-in form is optional.

23. A computer program product, embodied on a computer-readable medium, configured to perform the processes of claim 1.

24. An apparatus for invitation-based viral advertising, comprising:
an electronic device configured to:
deliver an advertisement to a first user;
upon acceptance by a second user of an invitation message from the first user regarding the advertisement, deliver the advertisement to the second user, wherein the delivery of the advertisement to the second user is performed either without further interaction or pursuant to one of:
presentation of an opt-in form to the second user and upon receipt of opt-in information for populating the opt-in form, processing the opt-in form for the second user; and
presentation of an optional opt-in form to the second user.

25. The apparatus of claim 24, wherein the first user and the second user have a trusted relationship, and wherein the electronic device comprises an advertising server.

26. The apparatus of claim 25, wherein at least a portion of the opt-in information is known to the advertising server prior to the presentation of the one of the opt-in form and the optional opt-in form to the second user.

27. The apparatus of claim 25, wherein an advertising software client resident on an advertising-receiving device utilized by the second user acts on behalf of the advertising server when the advertising-receiving device is offline.

28. The apparatus of claim 25, wherein an advertising software client resident on an advertising-receiving device utilized by the second user serves the advertisement from a cache of the advertising-receiving device instead of from the advertising server.

29. The apparatus of claim 24, wherein the invitation message comprises an indirectly sent invitation message sent by the first user and is forwarded to the second user by an intermediate network entity comprising an advertising server.

30. The apparatus of claim 24, wherein the invitation message comprises a directly sent invitation message sent by the first user to the second user without use of an advertising server.

31. The apparatus of claim 24, wherein the electronic device is further configured to, upon rejection by the second user of the invitation message regarding the advertisement, prohibit the delivery of the advertisement to the second user.

32. The apparatus of claim 24, wherein the invitation message comprises one of a default invitation message and a personalized invitation message.

33. The apparatus of claim 24, wherein the invitation message comprises a uniform resource identifier identifying an opt-in business logic resource at an advertising server.

34. The apparatus of claim 24, wherein the opt-in form is associated with an advertising network that originally provides the advertisement.

35. The apparatus of claim 34, wherein the electronic device is further configured to add a subscription of the second user to the advertising network upon the processing of the one of the opt-in form and the optional opt-in form for the second user.

36. The apparatus of claim 34, wherein the electronic device is further configured to, prior to the presenting of the one of theopt-in form and the optional opt-in form to the second user and upon a determination that a profile of the second user does not exist in association with the advertising network, deliver an informational page to the second user regarding at least one of the advertising network's terms, conditions, and benefits.

37. The apparatus of claim 34, wherein the processing of the one of the opt-in form and the optional opt-in form comprises one of creating and editing a profile of the second user associated with the advertising network.

38. The apparatus of claim 24, wherein the electronic device is further configured to perform at least one of a plurality of checks regarding at least one of a subscription status of the second user, a possibility of the second user to receive the invitation message, a willingness of the second user to receive the invitation message, and an eligibility of the second user to receive the invitation message.

39. The apparatus of claim 24, wherein the electronic device is further configured to determine whether the invitation message is potentially fraudulent.

40. The apparatus of claim 24, wherein the advertisement is one of a plurality of advertisements comprising an advertising campaign.

41. The apparatus of claim 24, wherein the advertisement is associated with an advertising campaign, and wherein delivery of the advertisement is based upon at least one criteria of the advertising campaign.

42. The apparatus of claim 41, wherein the at least one of the criteria of the advertising campaign comprises one of a location, a presence status, and a state of the second user, and wherein the delivery of the advertisement is one of adjusted and delayed until the one of the location, the presence status, and the state of the second user meets the criteria of the advertising campaign.

43. The apparatus of claim 24, wherein the electronic device is further configured to, prior to the delivery of the advertisement to the second user, at least one of choose and adjust at least one characteristic of the advertisement according to capabilities of an advertisement-receiving device utilized by the second user.

44. The apparatus of claim 24, wherein the electronic device is further configured to, prior to the delivery of the advertisement to the second user, at least one of choose and adjust at least one characteristic of the advertisement according to at least one of an application and capabilities of the application utilized for presenting the advertisement on an advertising-receiving device utilized by the second user.

45. The apparatus of claim 24, wherein the presentation of the opt-in form is optional.

46. An apparatus for invitation-based viral advertising, comprising:
means for delivering an advertisement to a first user;
means for, upon acceptance by a second user of an invitation message sent by the first user regarding the advertisement, delivering the advertisement to the second user, wherein the delivery of the advertisement to the second user is performed either without further interaction or pursuant to one of:
presentation of an opt-in form to the second user and upon receipt of opt-in information for populating the opt-in form, processing the opt-in form for the second user; and
presentation of an optional opt-in form to the second user.

47. The apparatus of claim 36, wherein the first user and the second user have a trusted relationship, and wherein the means for the delivery of the advertisement comprises an advertising server.
